(19) United States
(12) Patent Application Publication
(10) Pub. No.: US 2022/0143992 A1
(43) Pub. Date: May 12, 2022

(54) ALIGN PRINTING PAPER USING AIR BLOWER

(71) Applicant: Hewlett-Packard Development Company, L.P., Spring, TX (US)

(72) Inventors: Taehong Kim, Pangyo (KR); Seounguk Han, Suwon (KR); Joonghyun Kim, Pangyo (KR); Gyusun Lee, Pangyo (KR)

(73) Assignee: Hewlett-Packard Development Company, L.P., Spring, TX (US)

(21) Appl. No.: 17/416,621

(22) PCT Filed: Mar. 12, 2020
(86) PCT No.: PCT/US2020/022379

§ 371 Date: Jun. 21, 2021

(30) Foreign Application Priority Data
Jul. 29, 2019 (KR) 10-2019-0091702

(51) Int. Cl. B41J 11/00

(52) U.S. Cl. CPC B41J 11/00224; B41J 11/0045

(57) ABSTRACT

The inkjet image forming device comprises a post-processing device to post-process the paper ejected from the print engine, wherein the post-processing device comprises a loading part in which the paper conveyed from the print engine is to be loaded, and an air blower including an air blowing part to blow air toward the loading part, and a shutter to be rotatable between a closed position and an open position in the air blowing part to adjust an amount of air to be blown from the air blowing part.

### BACKGROUND

A print medium post-processing device is a device connected to an image forming device such as a printer or a multifunction printer, receive print media each on which an image is formed from the image forming device, and performs various types of post-processing on the printing media.

Such a print medium post-processing device may perform functions such as an alignment operation of aligning print media, a punching operation of punching a hole for binding the print media with a string or a binder, a stapling operation of binding a plurality of print media by using a stapling device, and a bookbinding operation of folding the plurality of print media in half to make the print media have a form of a book.

### BRIEF DESCRIPTION OF THE DRAWINGS

FIG. 1A is a schematic view of an inkjet image forming device with a built-in post-processing device according to an example;

FIG. 1B is a schematic view of an example in which a post-processing device is disposed outside an inkjet image forming device;

FIG. 2 is a side view of the post-processing device according to an example;

FIG. 3 is a perspective view of an air blower included in the post-processing device according to an example;

FIG. 4 is an exploded perspective view of the air blower included in the post-processing device according to an example;

FIG. 5 is a front view of the air blower included in the post-processing device according to an example;

FIG. 6 is a cross-sectional view taken along line A-A of FIG. 5 of an example in which each of one or more shutters is set to a first position;

FIG. 7 is a cross-sectional view taken along line A-A of FIG. 5 of an example in which each of the one or more shutters is set to a second position;

FIG. 8 is a side view of the air blower included in the post-processing device according to an example;

FIG. 9 is a cross-sectional view taken along line B-B of FIG. 8 of an example of an air movement route from a fan to air blowing parts; and

FIG. 10 is a block diagram of a simple configuration of an inkjet image forming device according to an example.

### DETAILED DESCRIPTION

Hereinafter, various examples will be described in detail with reference to the drawings. Examples described below may be modified into several different forms. To clearly describe features of examples, a detailed description for contents well-known to those skilled in the art to which the following examples belong will be omitted.

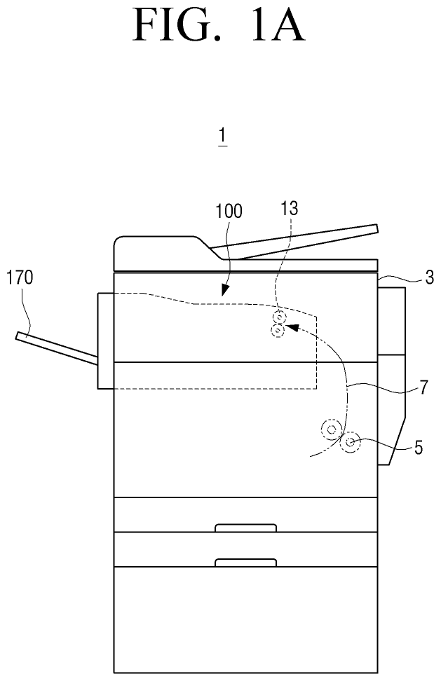

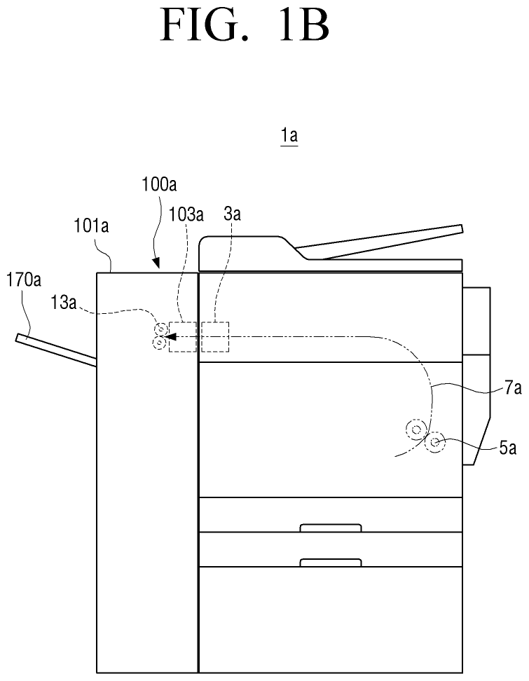

FIG. 1A is a schematic view illustrating an inkjet image forming device with a built-in post-processing device according to an example.

Referring to FIG. 1A, an inkjet image forming device 1 according to an example may form an image on paper by an inkjet method. Such an inkjet image forming device 1 may include a body 3, a plurality of conveying rollers 5, a conveying passage 7, and a post-processing device 100 disposed inside the inkjet image forming device 1.

The plurality of conveying rollers 5 of the inkjet image forming device 1 may sequentially convey sheets of printed paper toward the post-processing device 100 through the conveying passage 7.

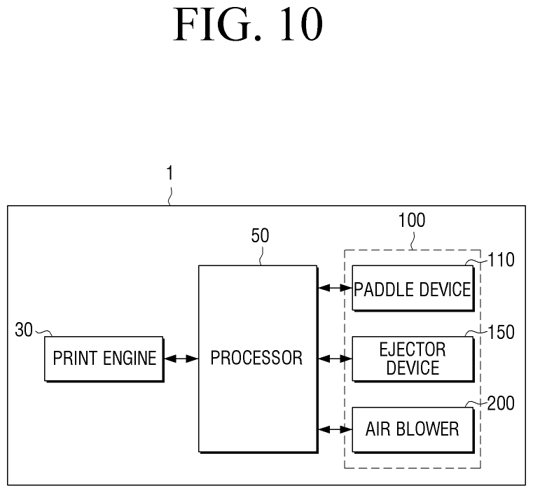

The inkjet image forming device 1 may transfer fed paper P to the post-processing device 100 through the conveying passage 7 in the inkjet image forming device 1 according to a control by a processor 50 (see FIG. 10). The post-processing device 100 may perform at least one of an alignment operation or a post-processing operation, and then eject the paper P transferred from the inkjet image forming device 1 to a tray 170 according to a control by the processor 50. Meanwhile, the post-processing device 100 may also be disposed outside the inkjet image forming device 1, unlike that illustrated FIG. 1A.

FIG. 1B is a schematic view illustrating an another example in which a post-processing device is disposed outside an inkjet image forming device.

Referring to FIG. 1B, a post-processing device 100a may be disposed in a main body 101a provided separately from an inkjet image forming device 1a. In this case, in the post-processing device 100a, an inkjet receiver 103a for receiving the paper ejected from the inkjet image forming device 1a may be formed at a position corresponding to a paper ejector 3a of the inkjet image forming device 1a. The inkjet image forming device 1a illustrated in FIG. 1B also forms an image on paper by the inkjet method.

A plurality of conveying rollers 5a of the inkjet image forming device 1a may sequentially convey sheets of printed paper toward the post-processing device 100a through a conveying passage 7a. In this case, the inkjet receiver 103a of the post-processing device 100a and the paper ejector 3a of the inkjet image forming device 1a may be disposed on the conveying passage 7a.

The inkjet image forming device 1a may transfer fed paper P to the post-processing device 100a through the conveying passage 7a in the inkjet image forming device 1a according to a control by the processor 50 (see FIG. 10). The post-processing device 100a may perform at least one of an alignment operation or a post-processing operation, and then eject the paper P transferred from the inkjet image forming device 1a to a tray 170a according to a control by the processor 50.

The following description will be provided under the assumption that an inkjet image forming device according to an example of the disclosure has a structure in which the post-processing device 100 is included inside the inkjet image forming device as illustrated in FIG. 1A.

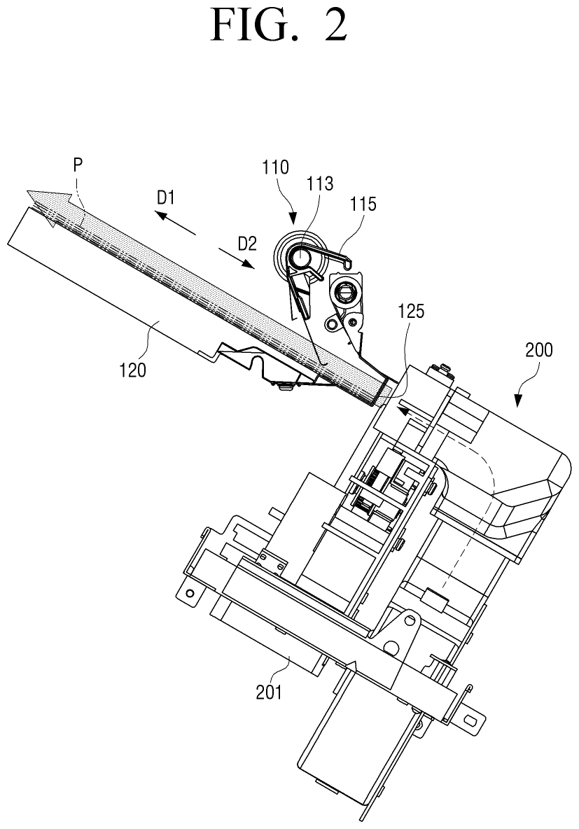

FIG. 2 is a side view illustrating the post-processing device according to an example.

Referring to FIG. 2, the post-processing device 100 according to the example of the disclosure is configured to receive a plurality of sheets of printed paper ejected from the inkjet image forming device 1, align the plurality of sheets of paper, and selectively perform a post-processing operation such as a stapling operation of binding the plurality of sheets of paper.

The post-processing device 100 may be mounted at an upper portion of the inkjet image forming device 1 and connected to a paper ejector of a print engine 30 (see FIG. 10) to receive sheets of paper P ejected through a paper ejecting roller 13 (see FIG. 10) and perform post-processing on the sheets of received paper P. The post-processing device 100 according to the example of the disclosure may be separably mounted in the inkjet image forming device 1, and thus may be selectively used by being coupled with the inkjet image forming device 1 when the sheets of paper P need to be post-processed. Further, the post-processing device 100 according to the example of the disclosure may also be separately disposed outside the inkjet image forming device 1 and operated.

The post-processing device 100 may include the plurality of conveying rollers 5 (see FIG. 10), the paper ejecting roller 13, a paddle device 110, a loading part 120, an end fence 125, and a pair of aligning members (not illustrated).

Further, the post-processing device 100 may further include the tray 170 in which a plurality of sheets of aligned paper or a plurality of sheets of post-processed paper are loaded, and an ejector device 150 (see FIG. 10) conveying the sheets of aligned or post-processed paper from the loading part 120 to the tray 170. The plurality of sheets of paper P aligned or aligned and post-processed in the loading part 120 may be ejected to the tray 170 by the ejector device 150.

Further, the post-processing device 100 may further include an air blower 200 enabling stable paper alignment by eliminating or significantly reducing a frictional force between sheets of paper at the time of aligning the sheets of paper. The air blower 200 blows air to assist in forming a gap between the sheets of paper, and thus may also be referred to as an air assist device. A configuration of the air blower 200 will be described below in detail with reference to the drawings.

The post-processing device 100 may include the conveying passage 7 for guiding the sheets of paper P transferred from the print engine 30 to the loading part 120, and the plurality of conveying rollers 5 disposed on the conveying passage 7 to allow the paper P to move along the conveying passage 7. Although FIG. 2 illustrates a case where the post-processing device 100 includes the conveying passage, the conveying roller, and the paper ejecting roller, but the disclosure is not limited thereto, and the conveying passage, the conveying roller, and the paper ejecting roller may be included as part of the inkjet image forming device 1, separately from the post-processing device 100.

The plurality of conveying rollers 5 are disposed on the conveying passage 7 and convey the paper P on which an image is formed toward the paper ejecting roller 13. The paper ejecting roller 13 is disposed at a portion where the conveying passage 7 ends, and may convey the paper P toward the loading part 120.

The loading part 120 is provided below one side of the paper ejecting roller 13, and the paper conveyed by the paper ejecting roller 13 may be loaded on an upper surface of the loading part 120. In this case, rear edges of the plurality of sheets of paper may be aligned in the loading part 120 by the paddle device 110 to be described 1a ter before the plurality of sheets of paper are conveyed to the tray 170.

The loading part 120 may be formed to be inclined downward toward the end fence 125 formed at a rear side of the loading part 120 such that the sheets of paper ejected from the paper ejecting roller 13 are loaded and easily aligned. Further, the loading part 120 may be disposed to be spaced apart from the paper ejecting roller 13 toward a lower side of the post-processing device 100, such that even when a stack of a plurality of sheets of paper ejected from the paper ejecting roller 13 and having a predetermined height is loaded, paper may be easily ejected from the paper ejecting roller 13 without a collision with the plurality of sheets of paper.

The loading part 120 may be formed to have an upper surface inclined upward, such that opposite sides and an end of each of the sheets of paper P loaded in the loading part 120 may be supported by one or more aligning members (not illustrated).

The paddle device 110 moving the paper P loaded in the loading part 120 to make one side end of the paper P be supported by the end fence 125 may be disposed above the loading part 120.

The post-processing device 100 according to the example of the disclosure may further include a stapler device (not illustrated). In this case, the end fence 125 may be disposed at the rear side of the loading part 120, such that the rear edges of the sheets of paper P conveyed to the loading part 120 come into contact with the end fence 125 and are thus aligned to facilitate an operation such as holding or stapling performed by the stapler device.

The sheets of paper provided to the post-processing device 100 may be loaded and aligned in an area surrounded by the loading part 120 and the end fence 125.

The paddle device 110 is disposed to be spaced apart from the upper surface of the loading part 120 by a predetermined distance, and may move the paper loaded in the loading part 120 toward the rear side of the loading part 120, that is, in a reverse direction D2 to align the sheets of paper.

The paddle device 110 may include a drive motor (not illustrate), a drive shaft 113 rotating by a driving force of the drive motor, and at least one paddle 115 mounted on the drive shaft 113 and rotating by rotation of the drive shaft 113 to come into contact with the paper P to align the paper P with other sheets of paper loaded in the loading part 120 in advance.

The drive shaft 113 may be disposed in a width direction of the paper and may rotate in one direction by the driving force of the drive motor.

The number of paddles 115 may be plural, and the paddle 115 may be formed so as to extend from an outer circumferential surface of the drive shaft 113 in a tangential direction of the drive shaft 113 while maintaining a predetermined interval in a rotation direction of the drive shaft 113. In this case, the paddle 115 may come into contact with an upper surface of the paper P at the time of rotating by the drive shaft 113 to convey the paper P toward the rear side of the loading part 120. In this case, a rear edge of the paper P conveyed by coming into contact with the paddle 115 may come into close contact with the end fence 125, to be aligned with rear edges of other sheets of paper P loaded in the loading part 120 in advance.

The ejector device 150 (see FIG. 10) may be disposed at the center of the loading part 120. The ejector device 150 may include guide members (not illustrated) disposed to face each other while having a predetermined interval therebetween, and moving members (not illustrated) disposed to face each other at inner sides of the guide members and rotating while describing a trajectory.

The ejector device 150 may move the plurality of sheets of paper aligned on the end fence 125 to a central portion of the loading part 120 by movement of the guide members. The ejector device 150 may hold rear ends of the plurality of sheets of paper moved to the central portion of the loading part to eject the plurality of sheets of aligned paper to the tray 170 by the moving members.

Hereinafter, a configuration of the air blower 200 according to an example of the disclosure will be described with reference to the drawings.

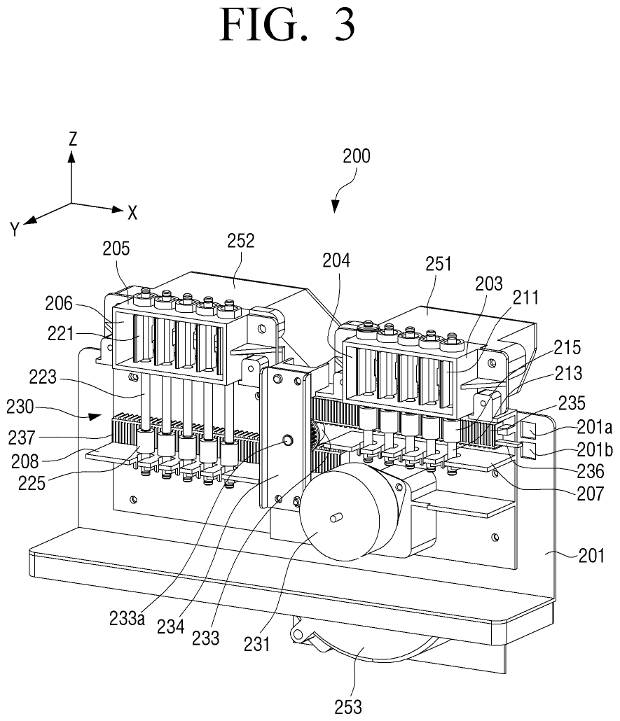

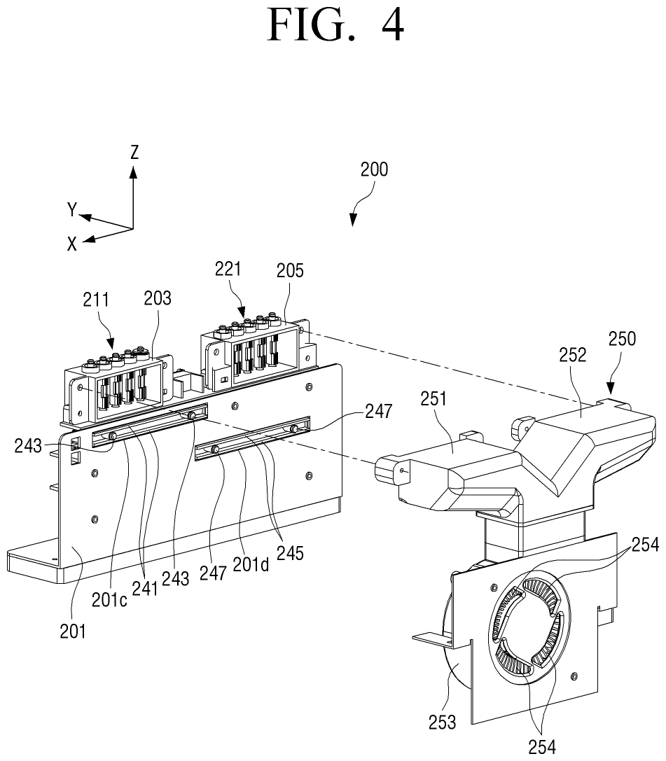

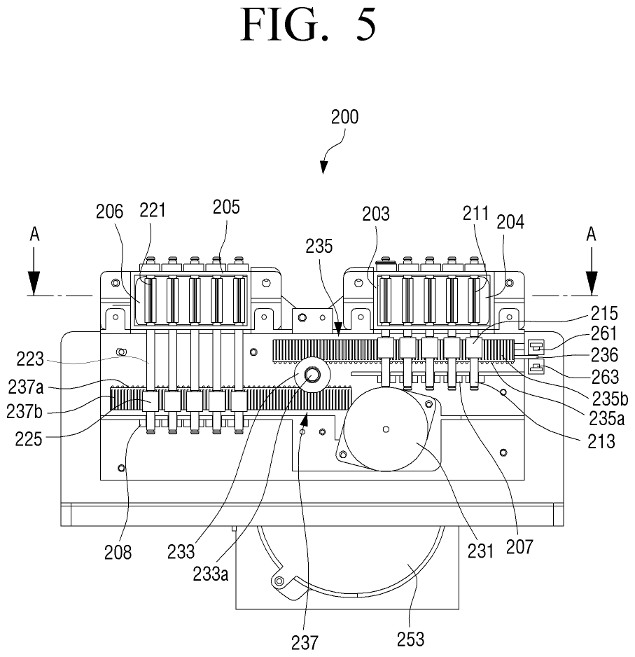

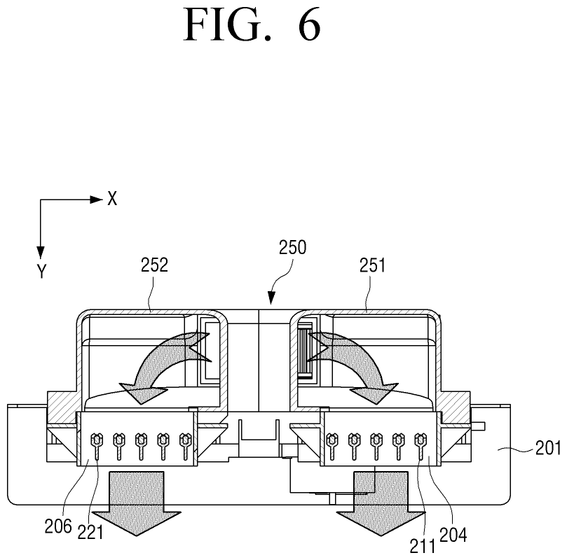

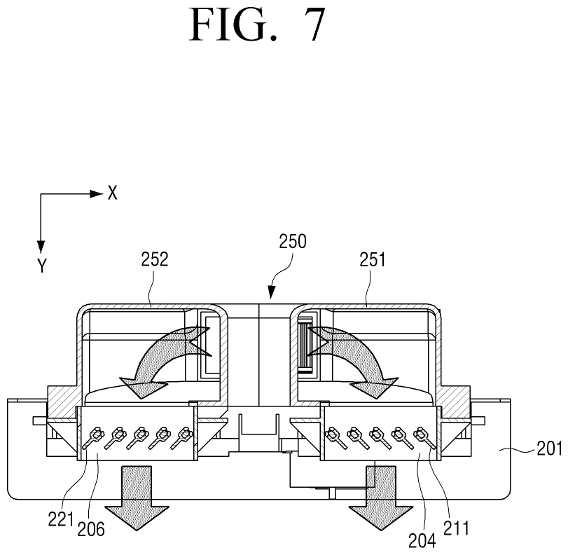

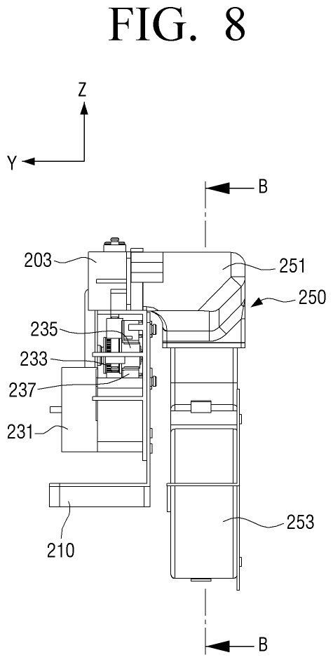

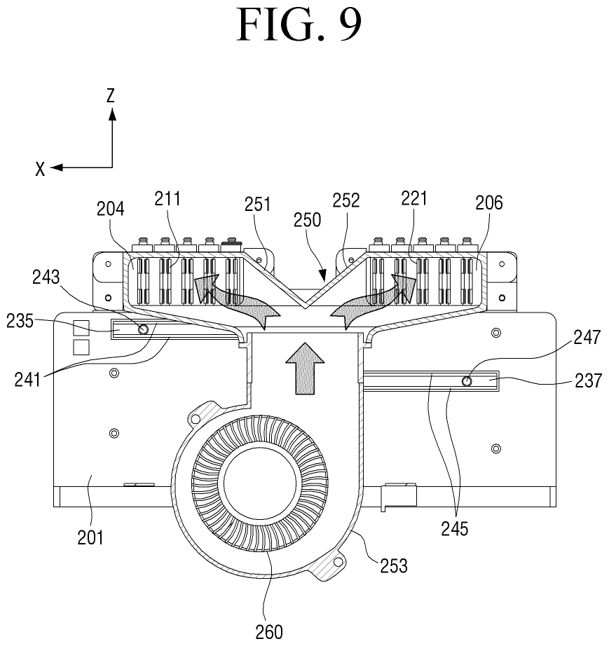

FIG. 3 is a perspective view illustrating the air blower included in the post-processing device according to an example, FIG. 4 is an exploded perspective view illustrating the air blower included in the post-processing device according to an example, FIG. 5 is a front view illustrating the air blower included in the post-processing device according to an example, FIG. 6 is a cross-sectional view taken along line A-A of FIG. 5 and illustrates an example in which each of one or more shutters is set to a first position, FIG. 7 is a cross-sectional view taken along line A-A of FIG. 5 and illustrates an example in which each of the one or more shutters is set to a second position, FIG. 8 is a side view illustrating the air blower included in the post-processing device according to an example, and FIG. 9 is a cross-sectional view taken along line B-B of FIG. 8 and illustrates an example of an air movement route from a fan to air blowing parts.

The air blower may include a single air blowing part or multiple blowing parts to blow air to a loading part in which paper is to be loaded. The air blower may also include a single shutter or multiple shutters to be rotatable between a closed position and an open position in the air blowing part or in each of the multiple air blowing parts to adjust an amount of air to be blown from the air blowing part or multiple air blowing parts toward the loading part.

Referring to FIGS. 3 and 4, the air blower 200 according to the example of the disclosure may include a support frame 201, and a first and second air blowing parts 203 and 205 blowing air toward the loading part 120. Further, the air blower 200 may include one or more first shutters 211 and one or more second shutters 221 for adjusting an amount of air blown from the first and second air blowing parts 203 and 205, respectively, and a shutter driving device 230 for rotating the one or more first shutters 211 and the one or more second shutters 221. Further, the air blower 200 may include a fan 260 forming and blowing an air current toward the first and second air blowing parts 203 and 205, and a duct 250 and a fan housing 253 for guiding the air current formed by the fan 260 to the first and second air blowing parts 203 and 205.

The support frame 201 is fixed in the post-processing device 100 and may support the first and second air blowing parts 203 and 205, the one or more first shutters 211, the one or more second shutters 221, and the shutter driving device 230.

The first and second air blowing parts 203 and 205 may be disposed at an upper portion of the support frame 201 so as to be spaced apart from each other with a predetermined interval therebetween.

Such a structure in which the first and second air blowing parts 203 and 205 are disposed to be spaced apart from each other is a structure in which air may be blown uniformly without being biased to any one side of paper when the one or more first shutters 211 and the one or more second shutters 221 simultaneously rotate by the shutter driving device 230 to which a rack and pinion drive method is applied, the air being blown from the first and second air blowing parts 203 and 205 toward the loading part 120.

The first and second air blowing parts 203 and 205 may have openings 204 and 206 blowing air toward the loading part 120, respectively. In this case, the openings 204 and 206 may be formed to have the same size.

The one or more first shutters 211 may be disposed in the first air blowing part 203 so as to be rotatable bidirectionally. The one or more first shutters 211 may be coupled, respectively, to one or more first hinge shafts 213 at an inner side of the first air blowing part 203, the one or more first hinge shafts 213 being arranged in parallel at intervals.

Each of the one or more first hinge shafts 213 may have one end rotatably connected to an upper end portion of the first air blowing part 203, and the other end penetrating through a lower end portion of the first air blowing part 203 to be rotatably connected to a first hinge rib 207 positioned below the first air blowing part 203.

The first hinge rib 207 is disposed on one surface of the support frame 201, and one or more insertion grooves into which the one or more first hinge shafts 213 are rotatably inserted may be formed in the first hinge rib 207.

The one or more second shutters 221 may be disposed in the second air blowing part 205 so as to be rotatable bidirectionally. The one or more second shutters 221 may be coupled, respectively, to one or more second hinge shafts 223 at an inner side of the second air blowing part 205, the one or more second hinge shafts 223 being arranged in parallel at intervals.

Each of the one or more second hinge shafts 223 may have one end rotatably connected to an upper end portion of the second air blowing part 205, and the other end penetrating through a lower end portion of the second air blowing part 205 to be rotatably connected to a second hinge rib 208 positioned below the second air blowing part 205.

In this case, the one or more second hinge shafts 223 may be formed to be longer than the one or more first hinge shafts 213. This is because a second rack 237 to be described 1a ter, which transfers a driving force to the second hinge shafts 223, is positioned lower than a first rack 235 which transfers a driving force to the first hinge shafts 213.

The second hinge rib 208 is disposed on one surface of the support frame 201, and one or more insertion grooves into which the one or more second hinge shafts 223 are rotatably inserted may be formed in the second hinge rib 208. The second hinge rib 208 may be positioned lower than the first hinge rib 207.

Each of the one or more first shutters 211 and the one or more second shutters 221 may be set to a first position or a second position to adjust an amount of air blown toward the loading part 120.

Referring to FIG. 6, when in the first position, the one or more first shutters 211 and the one or more second shutters 221 are arranged in parallel, such that a space between the one or more first shutters 211 and a space between the one or more second shutters 221 may be open and a first amount of air may be blown. In this case, the first position may be referred to as an open position.

Referring to FIG. 7, when in the second position, the one or more first shutters 211 and the one or more second shutters 221 maintain a state in which they rotate by a predetermined angle in opposite directions from each other. An interval between the one or more first shutters 211 and the one or more second shutters 221 when in the second position may be smaller than that between the one or more first shutters 211 and the one or more second shutters 221 when in the first position. Therefore, a second amount of air may be blown by the first and second air blowing parts 203 and 205, the second amount being smaller than the first amount.

Further, although not illustrated, the one or more first shutters 211 and the one or more second shutters 221 may be completely closed such that a gap is not formed between the one or more first shutters 211 and the one or more second shutters 221 when in the second position. In this case, the second position may be referred to as a closed position. Adjusting the amount of air to be blown, by controlling a rotation angle of each of the one or more first shutters 211 and the one or more second shutters 221 as described above may be based on a size of an image as in the following example.

The processor 50 may adjust an opening degree of each of the one or more first shutters 211 and the one or more second shutters 221 according to a size (ink coverage with respect to a size of paper) of an image to be formed on the paper to adjust the amount of air to be blown.

Here, the size (ink coverage) of the image may be confirmed from information regarding the image obtained by printing or scanning. Further, image coverage may vary depending on a predetermined standard.

For example, in a case where the image coverage is high, the amount of air to be blown may be increased by increasing the opening degree of each of the one or more first shutters 211 and the one or more second shutters 221. In contrast, in a case where the image coverage is low, the amount of air to be blown may be decreased by decreasing the opening degree of each of the one or more first shutters 211 and the one or more second shutters 221. Further, adjusting the amount of air to be blown by the air blower 200 may also be based on a size (A3, A4, or the like) of paper conveyed to the print engine 30 (see FIG. 10).

Referring to FIG. 5, the shutter driving device 230 may rotate the one or more first shutters 211 and the one or more second shutters 221 in a clockwise direction and a counterclockwise direction to set each of the one or more first shutters 211 and the one or more second shutters 221 to any one position between the first position and the second position. For example, each of the one or more first shutters 211 and the one or more second shutters 221 may rotate to any one of the first position (completely open position), the second position (closed position), or a third position between the first position and the second position.

The shutter driving device 230 may have a rack and pinion structure to simultaneously rotate the one or more first shutters 211 and the one or more second shutters 221.

The shutter driving device 230 may include a drive motor 231 that may rotate in a normal direction and a reverse direction, a pinion 233 receiving a driving force from the drive motor 231, first and second racks 235 and 237 each gearing into the pinion 233, and one or more first roller gears 215 and one or more second roller gears 225 each gearing into the first or second rack 235 or 237.

The drive motor 231 may include a decelerator (not illustrated) and be fixed to the support frame 201.

A drive shaft (not illustrated) of the drive motor 231 may be disposed to be biased away from a rotation shaft 233a of the pinion 233.

Such a biased disposition may help solve an issue that an area occupied by the shutter driving device 230 in a front-rear direction in the post-processing device 100 is increased when a rotation shaft of the drive motor 231 is coupled at the center of rotation of the pinion 233, and as a result, a size of the air blower 200 is increased.

Further, for the biased disposition, a drive belt (not illustrated) may be used to transfer a rotation force of the drive motor 231 to the rotation shaft 233a of the pinion 233. In this case, the drive belt may include a plurality of gear teeth formed along an inner surface of the drive belt, like a timing belt, and the drive belt may gear into the rotation shaft of the drive motor 231 and the rotation shaft 233a of the pinion 233.

The pinion 233 rotates in a clockwise direction and a counterclockwise direction together with the rotation shaft 233a. The rotation shaft 233a has one end rotatably connected to the support frame 201 and the other end rotatably connected to a bracket 234 (see FIG. 3). An upper end portion and a lower end portion of the bracket 234 may be fixed to the support frame 201.

The first and second racks 235 and 237 may each gear into the pinion 233 and simultaneously receive a driving force from the pinion 233 to linearly move in opposite directions from each other.

Referring to FIG. 4, one or more first guide protrusions 243 may be formed on a back surface of the first rack 235, the first guide protrusions 243 sliding along a rail 241 disposed in a first guide hole 201c formed in the support frame 201. Accordingly, the first rack 235 may linearly move bidirectionally in an X-axis direction.

Referring to FIG. 5, first gear teeth 235a gearing into the pinion 233 may be formed on a bottom surface of the first rack 235, and second gear teeth 235b gearing into the one or more first roller gears 215 coupled with the one or more first hinge shafts 213, respectively, may be formed on a front surface of the first rack 235.

As a result, the first rack 235 may transfer the driving force transferred from the pinion 233 to the one or more first roller gears 215. As the one or more first roller gears 215 rotate in the normal direction or the reverse direction, the one or more first shutters 211 may rotate together with the one or more first hinge shafts 213 to be set to the first position, the second position, or the third position.

A sensed protrusion 236 may be formed at one side end of the first rack 235. The sensed protrusion 236 may be sensed by an optical sensor including a light emitter 261 and a light receiver 263. As the sensor for sensing the sensed protrusion 236, various sensors such as an infrared sensor and a motion sensor may be used, in addition to the optical sensor.

The light emitter 261 and the light receiver 263 may be disposed to protrude by a predetermined length through a pair of through-holes 201a and 201b (see FIG. 3) formed in the support frame 201, respectively, toward an area in front of the support frame 201.

Accordingly, the sensed protrusion 236 may be disposed between the light emitter 261 and the light receiver 263 when the first rack 235 moves in a +X-axis direction (to the right in FIG. 5), and may escape from between the light emitter 261 and the light receiver 263 when the first rack 235 moves in a −X-axis direction (to the left in FIG. 5).

For example, a position at which the sensed protrusion 236 is sensed by the optical sensor may correspond to the first position of the one or more first shutters 211 and the one or more second shutters 221, and a position at which the sensed protrusion 236 is not sensed by the optical sensor may correspond to the second position of the one or more first shutters 211 and the one or more second shutters 221.

Although a case where the sensed protrusion 236 is formed on the first rack 235 is described in the example of the disclosure, the disclosure is not limited thereto, and it is a matter of course that the sensed protrusion 236 may also be formed on the second rack 237. In this case, a mounting position of the optical sensor may also be changed such that the optical sensor may sense the sensed protrusion.

The processor 50 may control each of the one or more first shutters 211 and the one or more second shutters 221 to rotate to the first position or the second position through a sensing signal transmitted from the optical sensor.

The second rack 237 may receive the driving force from the pinion 233 and transfer the driving force to the one or more second roller gears 225, similarly to the first rack 235.

That is, referring to FIG. 4, one or more second guide protrusions 247 may be formed on a back surface of the second rack 237, the second guide protrusions 247 sliding along a rail 245 disposed in a second guide hole 201d formed in the support frame 201. Accordingly, the second rack 237 may linearly move bidirectionally in an X-axis direction, and a direction in which the second rack 237 moves may be opposite to a direction in which the first rack 235 moves.

Referring to FIG. 5, third gear teeth 237a gearing into the pinion 233 may be formed on an upper surface of the second rack 237, and fourth gear teeth 237b gearing into the one or more second roller gears 225 coupled with the one or more second hinge shafts 223, respectively, may be formed on a front surface of the second rack 237.

As a result, the second rack 237 may transfer the driving force transferred from the pinion 233 to the one or more second roller gears 225. As the one or more second roller gears 225 rotate in the normal direction or the reverse direction, the one or more second shutters 221 may rotate together with the one or more second hinge shafts 223 to be set to the first position or the second position.

Referring to FIG. 8, the fan 260 forming and blowing the air current toward the first and second air blowing parts 203 and 205 may be positioned behind the support frame 201.

The fan 260 may be any one of a turbo fan, an air foil fan, and a sirocco fan, each of which sucks air in an axial direction and discharges in a circumferential direction.

Referring to FIG. 9, the fan 260 may be rotatably disposed in the fan housing 253 and may suck air through one or more air suction ports 254 (see FIG. 4) formed in a back surface of the fan housing 253. The one or more air suction ports 254 may be arranged in a circumferential direction at the same intervals around the center of rotation of the fan 260. With such an arrangement of the one or more air suction ports 254, a uniform amount of sucked air over the entire fan 260 may be achieved.

The duct 250 is connected to an upper side of the fan housing 253. The duct 250 guides the air discharged from the fan housing 253 to each of the first and second air blowing parts 203 and 205.

A lower side of the duct 250 may communicate with the fan housing 253, and the duct 250 may include first and second guides 251 and 252 branched out toward the first and second air blowing parts 203 and 205, respectively.

Referring to FIG. 9, the air that is present in the fan housing 253 because of the air current formed by the fan 260 moves to the duct 250 and then is guided to the first and second air blowing parts 203 and 205 through the first and second guides 251 and 252. Referring to FIG. 6, the air guided to the first and second air blowing parts 203 and 205 may be blown toward the loading part 120 through the openings 204 and 206 of the first and second air blowing parts 203 and 205.

Once the air is blown toward the loading part 120 as described above, an air gap may be formed between sheets of paper P conveyed from the print engine 30 and ejected to the loading part 120. That is, an air gap may be formed between a sheet of paper already loaded in the loading part 120 and a next sheet of paper.

As a result, a friction between the next sheet of paper and the already loaded paper may not occur or may be significantly reduced in a process in which the next sheet of paper is moved in the reverse direction D2 (see FIG. 2) by the paddle device 110 and a rear edge of the next sheet of paper comes into contact with the end fence 125. Accordingly, paper alignment may be performed easily even in a case where paper printed by ink jetting is ejected to the loading part 120 in a state in which the printed paper is not dried.

Hereinafter, paper alignment processes of the inkjet image forming device 1 including the post-processing device 100 according to the example of the disclosure will be sequentially described.

The inkjet image forming device 1 forms an image on first paper by using the print engine 30.

The inkjet image forming device 1 provides the first paper on which the image is formed to the post-processing device 100 by using the paper ejecting roller 13.

The paddle device 110 may move the first paper conveyed to the loading part 120 of the post-processing device 100 in the direction D2 (see FIG. 2) reverse to a conveying direction D1 (see FIG. 2) to make the rear edge of the first paper come into contact with the end fence 125, thereby making the paper P move to an alignment position.

The air blower 200 may blow air toward the loading part 120 and the first paper before or after the first paper is loaded in the loading part 120. In this case, an air gap may be formed between the first paper and the loading part 120, and thus a frictional force between the first paper and the loading part 120 may be eliminated or significantly reduced when the paddle 115 of the paddle device 110 moves the first paper in the reverse direction D2 by coming into contact with the first paper. As a result, the first paper may be stably moved to a paper alignment position.

In a case where second paper is provided to the post-processing device 100 by the paper ejecting roller 13, the air blower 200 continuously blows air toward the first paper and the second paper.

As such, a time at which the air blower 200 starts blowing of air may correspond to a time which an operation of the paddle device 110 starts, a time at which the air blower 200 ends the blowing of air may correspond to a time which the operation of the paddle device 110 ends, and those times may be controlled by the processor 50.

That is, once the paper conveyed to the loading part 120 by the paper ejecting roller 13 is sensed (in this case, the inkjet image forming device or the post-processing device may include a sensor (not illustrated) for sensing the paper conveyed to the loading part 120), the paddle device 110 and the air blower 200 may be turned on to perform paddling and blowing of air, respectively. In this case, the processor 50 may turn on the paddle device 110 and the air blower 200 at the same time or at different times.

In a case of turning on the paddle device 110 and the air blower 200 at different times, the air blower 200 may be turned on at a predetermined time (for example, within one second after the paddle device 110 is turned on) after turning on the paddle device 110 first. For example, the air blower 200 may be turned on at a time at which the paddle 115 starting rotation from an initial position comes into contact with paper when the paddle 115 of the paddle device 110 is driven.

Further, in a case where the paper conveyed to the loading part 120 by the paper ejecting roller 13 is not sensed, the paddle 115 of the paddle device 110, and the fan 260 of the air blower 200 may be turned off.

As a result, an air gap may be formed between the first paper and the second paper, and a frictional force generated between the first paper and the second paper that is conveyed in the reverse direction D2 by the paddle device 110 may be eliminated or significantly reduced. As a result, the rear edge of the second paper comes into contact with the end fence 125, and thus the second paper may be stably conveyed to the paper alignment position like the first paper.

Further, the stapler device holds one ends of the first paper and the second paper aligned. In a process in which the stapler holds the one ends of the first paper and the second paper, the one ends of the first paper and the second paper loaded in the loading part 120 may be held by using a holding mode of the stapler device in a printing operation of performing printing on a plurality of sheets of paper.

When the printing operation of performing printing on a plurality of sheets of paper ends, the stapler device may staple one ends of the sheets of paper. The stapler device may bind a plurality of sheets of paper into a bundle by using a stapling mode.

Sheets of post-processed paper or aligned paper without being post-processed may be moved from the loading part 120 to the tray 170 by the ejector device 150. For example, a plurality of sheets of paper stapled by the stapler device may be ejected to the tray 170 by the ejector device 150.

Meanwhile, the paper alignment method according to the example described above may be implemented by a program and be provided to the inkjet image forming device. Particularly, a program including the paper alignment method may be stored and provided in a non-transitory computer readable medium.

The non-transitory computer-readable medium is not a medium that stores data therein for a while, such as a register, a cache, or a memory, but may refer to a medium that semi-permanently stores data therein and is readable by a device. In detail, the various application or programs described above may be stored and provided in the non-transitory computer readable medium such as a compact disk (CD), a digital versatile disk (DVD), a hard disk, a Blu-ray disk, a universal serial bus (USB) memory, a memory card, or a read only memory (ROM).

FIG. 10 is a block diagram illustrating a simple configuration of an inkjet image forming device according to an example.

Referring to FIG. 10, the inkjet image forming device 1 may include the print engine 30, the processor 50, and the post-processing device 100. The post-processing device 100 may include the paddle device 110, the ejector device 150, and the air blower 200. Further, the post-processing device 100 according to the example may further include the stapler device (not illustrated).

The print engine 30 performs an image forming operation. For example, the print engine 30 may perform the image forming operation by forming an image on an image forming medium and transferring the formed image to paper.

The print engine 30 forms an image on fed paper P through a predetermined image forming process such as an electrophotographic method, a thermal transfer method, and an inkjet method. A configuration of the print engine 30 is well known in the art, and thus a detailed description thereof will be omitted.

The post-processing device 100 is configured to be able to selectively perform a punching operation of punching a hole by receiving printed paper ejected from the inkjet image forming device 1, a stapling operation of binding a plurality of sheets of paper, a bookbinding operation of folding a plurality of sheets of paper in half to make the paper has a form of a book, and the like.

The processor 50 controls the respective components in the inkjet image forming device 1. Once a printing command is received, the processor 50 may control the print engine 30 to receive paper P, form an image, and provide the paper P on which the image is formed to the post-processing device 100. The processor 50 may control the post-processing device 100 to perform a post-processing operation such as binding, folding, stapling, or punching on the paper on which the image is formed according to the printing command.

In a case where the received printing command does not include the post-processing operation, the processor 50 may control the paddle device 110 to align a plurality of sheets of paper P ejected from the print engine 30, and may control the ejector device 150 to eject the plurality of sheets of aligned paper P to the tray 170.

In a case where the received printing command includes the post-processing operation, the processor 50 may control the paddle device 110 to align a plurality of sheets of paper P ejected from the print engine 30, may control the stapler device to staple one ends of the plurality of sheets of paper P, and may control the ejector device 150 to eject the plurality of sheets of stapled paper P to the tray 170.

Particularly, the processor 50 may control the paddle device 110 to move, in the direction D2 reverse to the conveying direction D1, the paper P provided from the print engine 30 to the post-processing device 100 and loaded in the loading part 120 (see FIG. 3), to align sheets of paper P ejected in the conveying direction D1.

The paddle device 110 may come into contact with the upper surface of the paper P to move the paper P in the reverse direction D2. The end fence 125 (see FIG. 2) for aligning rear edges of sheets of paper P may be formed at the rear side of the loading part 120. In this case, the paper P moves in the reverse direction according to the operation of the paddle device 110 and a rear edge of the paper P comes into contact with the end fence 125, as a result the paper P may be aligned with other sheets of paper P loaded in the loading part 120 in advance.

However, a next sheet of paper may not move to an alignment position even when the paddle device 110 is driven, due to a frictional force generated between a sheet of paper loaded in the loading part 120 in advance and the next sheet of paper loaded on the paper loaded in the loading part 120 in advance. Here, a paper state may mean a state in which a frictional force between sheets of paper is large, for example, a state in which the paper is wet because ink jetted onto the paper in the print engine 30 is not dried, or a state in which a surface roughness of the paper is high.

In order to prevent the frictional force between sheets of paper from inhibiting paper alignment, the processor 50 may control the air blower 200 to continuously blow a predetermined amount of air toward sheets of paper loaded in the loading part 20 while the sheets of paper are aligned in the post-processing device 100. By doing so, an air gap may be formed between a sheet of paper loaded in the loading part 120 in advance and a next sheet of paper to eliminate or significantly reduce a frictional force between sheets of paper when the paper is conveyed in the reverse direction D2 by the paddle device 110, such that a rear edge of the next paper comes into contact with the end fence 25, thereby enabling stable paper alignment.

That is, the processor 50 may control the paddle device 110 and the air blower 200 to eliminate or minimize a frictional force between sheets of paper P generated in a process of aligning the sheets of paper P. Although examples of the disclosure have been illustrated and described hereinabove, the disclosure is not limited thereto, but may be variously modified by those skilled in the art to which the disclosure pertains without departing from the spirit and scope of the disclosure claimed in the claims. These modifications are to fall within the scope of the claims.

What is claimed is:

1. A post-processing device comprising:
a loading part in which paper is to be loaded; and
an air blower including an air blowing part to blow air toward the loading part, and a shutter to be rotatable between a closed position and an open position in the air blowing part to adjust an amount of air to be blown from the air blowing part toward the loading part.

2. The post-processing device as claimed in claim 1, comprising a paddle device to convey the paper in the loading part to a paper alignment position,
wherein the air blower is to be turned on or off depending on whether the paddle device is driven.

3. The post-processing device as claimed in claim 2, wherein the air blower is to be driven at a time at which the paddle device is turned on, or at a time at which a predetermined time elapses after the paddle device is turned on.

4. The post-processing device as claimed in claim 1, wherein the air blower includes a plurality of air blowing parts to blow air toward the loading part, and a plurality of shutters to be rotatable between a closed position and an open position in each of the plurality of air blowing parts.

5. The post-processing device as claimed in claim 1, wherein the air blower is to adjust the amount of air to be blown, according to coverage by an image formed on the paper.

6. The post-processing device as claimed in claim 1, wherein the air blower further comprises a fan; and a duct to guide an air current formed by the fan toward the air blowing part.

7. The post-processing device as claimed in claim 1, wherein the air blower further comprises a shutter driving device to rotate the shutter between the closed position and the open position.

8. The post-processing device as claimed in claim 7, wherein the shutter driving device is to adjust a rotation angle of the shutter according to an amount of air to be blown.

9. The post-processing device as claimed in claim 8, wherein the air blowing part is disposed behind the loading part and is to blow air toward the paper in the loading part.

10. The post-processing device as claimed in claim 7, wherein the shutter driving device comprises a drive motor; a pinion to be rotated by the drive motor in a normal direction and a reverse direction; a first rack to be geared into the pinion and driven in an opposite direction from a second rack; and a roller gear to be geared into the first rack and connected to a hinge shaft of the shutter.

11. The post-processing device as claimed in claim 10, comprising a sensor to sense positions of the rack.

12. An inkjet image forming device comprising:
a main body;
a print engine to be disposed in the main body and form an image on paper; and
a post-processing device to post-process the paper ejected from the print engine,
wherein the post-processing device comprises a loading part in which the paper conveyed from the print engine is to be loaded, and an air blower including an air blowing part to blow air toward the loading part, and a shutter to be rotatable between a closed position and an open position in the air blowing part to adjust an amount of air to be blown from the air blowing part toward the loading part.

13. The inkjet image forming device as claimed in claim 12, wherein the air blower further comprises a shutter driving device to rotate the shutter between the closed position and the open position.

14. The inkjet image forming device as claimed in claim 12, comprising a paddle device to convey the paper in the loading part to a paper alignment position,
wherein the air blower is to be turned on or off depending on whether the paddle device is driven, in such a manner that the air blower is to be driven at a time at which the paddle device is turned on, or at a time at which a predetermined time elapses after the paddle device is turned on.

15. The inkjet image forming device as claimed in claim 12, wherein the air blower is to adjust the amount of air to be blown, according to coverage by the image formed on the paper.
